(19) United States
(12) Patent Application Publication
(10) Pub. No.: US 2006/0288960 A1
(43) Pub. Date: Dec. 28, 2006

(54) Pet collar with integral leash

(76) Inventor: Michael A. Harrison, Windsor, CA (US)

Correspondence Address: LARRY D. JOHNSON;REGISTERED PATENT ATTORNEY, Suite110, 165 N. Redwood Dr., San Rafael, CA, 94903, US

(21) Appl. No.: 11/475,513

(22) Filed: Jun. 27, 2006

Related U.S. Application Data
(60) Provisional application No. 60/694,662, filed on Jun. 27, 2005.

(51) Int. Cl. A01K 27/00

(52) U.S. Cl. 119/794

(57) ABSTRACT

A pet collar with an integral, retractable leash mechanism includes a flexible collar portion with a releasable buckle and means for length adjustment. A retractable cable is contained in a housing mounted on the collar. The retractable cable is normally biased to retract into the housing, but can be prevented from retracting by engaging a manual lock, so that the cable may be used as a leash. The cable terminates in a swivel attachment, which is itself connected to a hand strap portion. The hand strap includes means for releasable attachment to itself and to the collar, so that the hand strap may be secured flush against the collar when not in use.

### CROSS REFERENCE To RELATED APPLICATIONS

This application claims the benefit of U.S. Provisional Patent Application Ser. No. 60/694,662, filed 27 Jun. 2005.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to pet collars and leashes, and more particularly to an improved pet collar apparatus with an integral leash portion.

### BACKGROUND INFORMATION AND DISCUSSION OF RELATED ART

Pet collars and leashes are well known and in widespread use. Most collars and leashes are separate, discrete articles, such that a pet owner must always have access to a leash to connect to a pet's collar in order to properly restrain and control the pet. However, there are often situations where the pet owner would like to walk or exercise the pet, but a leash is not readily available.

U.S. Pat. No. 6,367,428 to Forte discloses a combination dog collar and leash system. A strap has a length with a midpoint and with an interior surface and an exterior surface and an inner end and an outer end. The outer end is folded to form a first loop constituting a handle with a first stitching at the outer end forming a leash. The inner end is folded to form an overlapping extent with a second stitching at the inner end. A first segment of a pile type fastener is secured to the strap from adjacent to the outer end along the length of the handle. A second segment of a pile type fastener is secured to the exterior surface from adjacent to the inner end. A portion of a plastic buckle is secured in the second loop. A portion of a plastic buckle is slidably secured to the strap adjacent to the center of the strap.

U.S. Pat. No. 6,481,382 to Cohn describes an apparatus for controlling the movement of an animal using an integral collar and self-retracting leash apparatus. According to the invention, an elastomeric cord is attached to a strap, which is adapted to be secured around the neck of an animal. In the preferred embodiment of the invention, the strap encloses the fixed end of the elastomeric cord, which is attached to an anchor located near the first end of the strap. The cord extends from the anchor in a direction substantially parallel to the longitudinal axis of the strap and passes around about 180.degree. of a pulley or spool located near the second end of the strap. The cord then extends from the pulley in a direction substantially parallel to the longitudinal axis of the strap to an opening located near the first end of the strap. The free end of the cord passes through the opening in the strap. A handle is attached to the free end of the cord to prevent the free end from retracting through the opening into the enclosed area of the strap and to allow the user to easily grasp the cord to control the movement of the animal.

U.S. Pat. No. 6,581,547 to Austin teaches a pet collar with an integrated retractable leash which includes a recoil mechanism having a coiled spring coupled to an end of the leash, thereby generating the retractability of the leash. At an opposing end to the recoil mechanism is a removable handle for securely maintaining control of the animal wearing the pet collar and retractable leash. The pet collar is adjustable to accommodate a variety of neck sizes of an animal. The pet collar also includes a ring to accommodate a stand-alone leash.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention provides a pet collar with an integral, retractable leash mechanism. The inventive apparatus includes a flexible collar portion made of fabric, leather, or other suitable material, with a releasable buckle and means for collar length adjustment, all as is well known in the art. An extendable and retractable line or cable is contained in a housing mounted on the collar, and preferably adjacent the releasable buckle. The retractable cable is preferably normally spring-loaded or otherwise biased to retract into the housing, so that the cable may used as a retracting-type leash, but can also be prevented from retracting after extension from the housing by engaging a manual lock, so that the extended cable may then be used as a static leash. The cable preferably terminates in a swivel attachment, which is itself connected to a loop or hand strap portion. The hand strap preferably includes a plurality of snaps, velcro, or other means for releasable attachment to itself and to the collar portion, so that the hand strap may be secured flush against the collar portion when not in use, and the hand strap loop is secured together and does not expand or otherwise create an opening which would create the potential for catching on an object as the pet is walking or running. The hand strap may also be used as a “T” handle if desired.

The inventive apparatus thus provides an “instant leash” when needed by a pet owner to keep a pet under direct control, and eliminates the need for the pet owner to locate a standard leash to attach to the pet's collar when walking or exercising the pet. The inventive apparatus is primarily intended for quick or temporary use, but may be used as a permanent leash as appropriate.

It is therefore an object of the present invention to provide a new and improved pet collar and leash.

It is another object of the present invention to provide a new and improved pet collar with an integral leash.

A further object or feature of the present invention is a new and improved leash handle which can be secured to a collar.

An even further object of the present invention is to provide a novel retractable leash apparatus.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of a pet collar with integral leash of this invention, illustrating a collar, hand strap, and retractable cable; and

FIGS. 2A-2C are a series of perspective views depicting the hand strap being separated from the collar and extended away from the collar by extension of the retractable cable to form a leash.

### DETAILED DESCRIPTION OF THE INVENTION

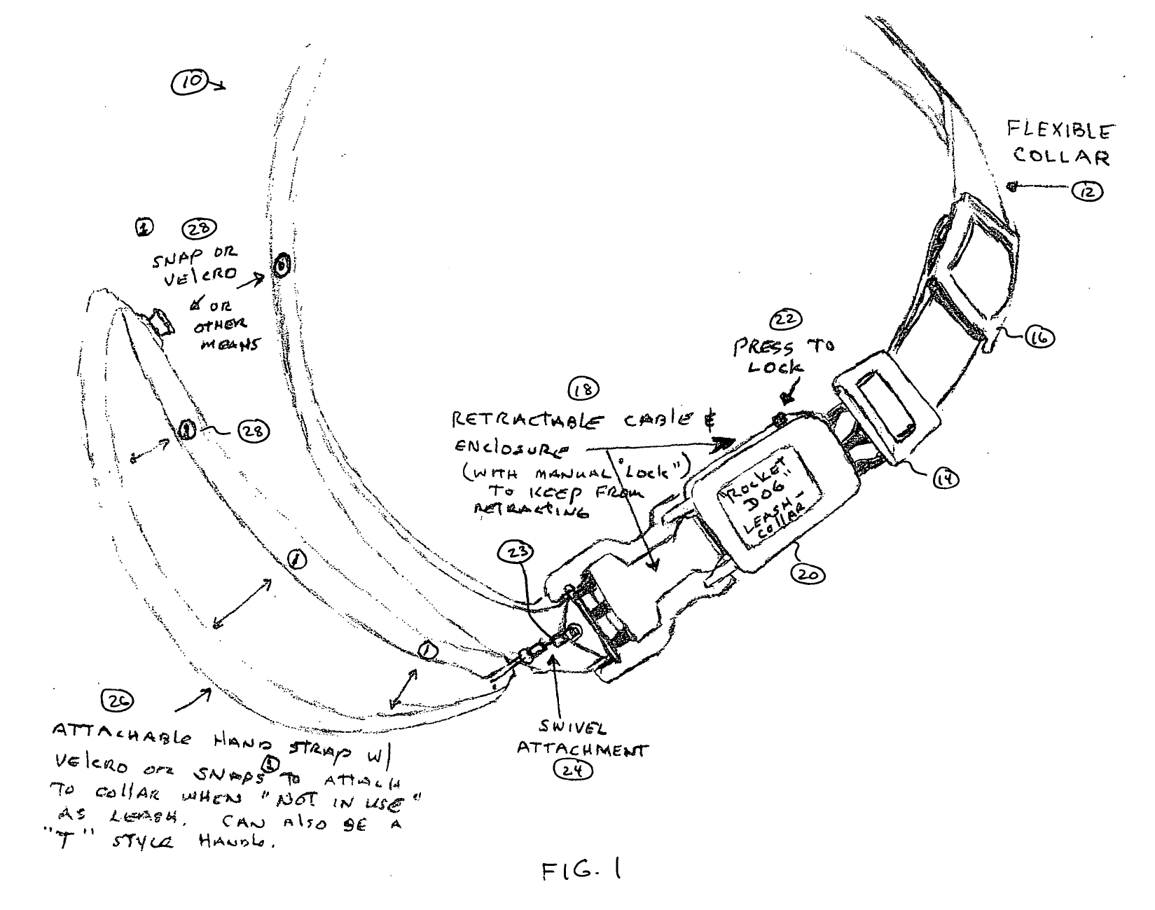

Referring to FIG. 1, there is illustrated therein a new and improved pet collar with integral leash, generally denominated 10 herein. The inventive collar and leash apparatus 10 includes a flexible collar portion 12 made of fabric, leather, or other suitable material, with a releasable buckle 14 and length adjustment buckle 16. An extendable and retractable cable 18 is contained in a housing 20 mounted on the collar 12, and preferably adjacent the releasable buckle 14. The retractable cable 20 is normally spring-loaded or otherwise biased to retract into the housing 20, but can be prevented from retracting by engaging a manual lock 22, so that the cable may be used as a leash. The cable terminal end 23 bears a swivel attachment 24, which is itself connected to a loop or hand strap portion 26. The hand strap preferably includes snaps, velcro hook-and-loop fastener, or other fastening means 28 on the inside of the loop and the outside of at least one side of the loop for releasable attachment of the loop to itself and to the collar portion 12, so that the hand strap 26 may be secured flush against the collar portion 12 when not in use, and the hand strap loop is closed and does not expand or otherwise create a danger of catching on an object. The hand strap may also be used as a “T” handle if desired, by selective fixation of the appropriate snaps or other securing medium.

The very end of the hand strap 26 may include a small portion intentionally unsecured to the other side of the hand strap or loop, so as to allow insertion of a finger to peel it open (and to insert the hand. Alternatively, the hand strap may include a small snap at that point to help keep it in place, or even a small pocket or other feature to tuck the very end of the hand strap when it is not being used.

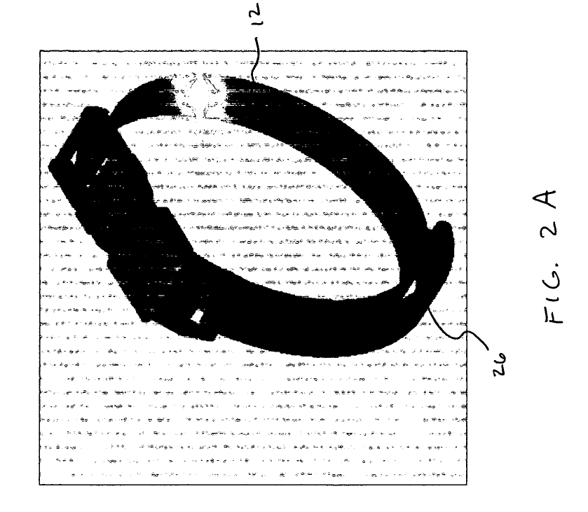

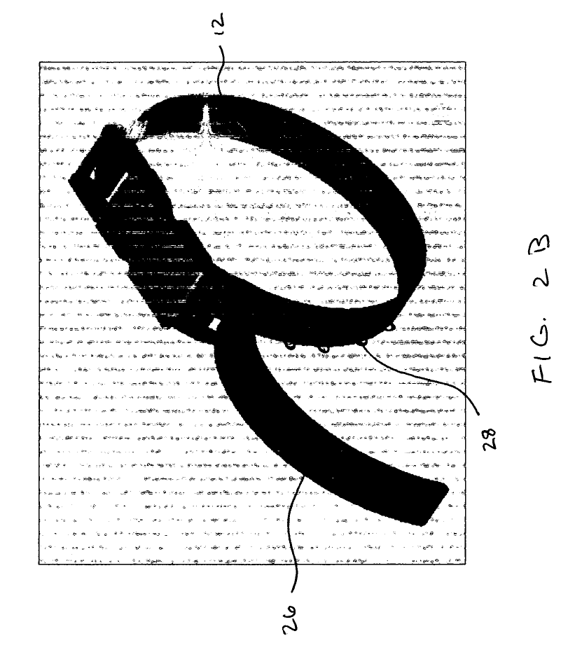

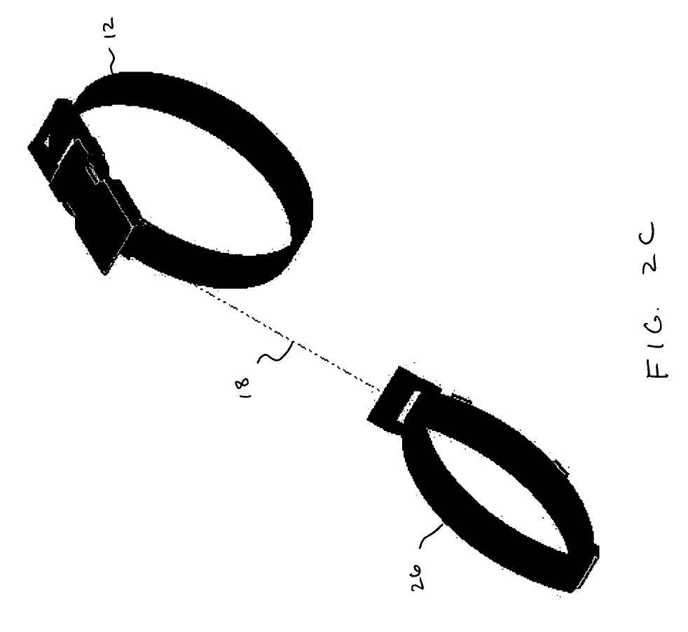

FIGS. 2A-2C are a series of perspective views depicting the hand strap 26 of the inventive apparatus being separated from the collar 12 and extended away from the collar by extension of the retractable cable 18 to form a leash. Sequentially, FIG. 2A illustrates the hand strap 26 secured flush against the collar portion 12 as when it is not in use, such that the hand strap loop is secured together and does not expand or otherwise create an opening which would create the potential for catching on an object as the pet is walking or running. FIG. 2B depicts the hand strap 26 being initially separated from the collar 12 by release of the snaps 28. FIG. 2C depicts the hand strap 26 being extended away from the collar 12 by extension of the retractable cable 18, and the loop of the hand strap being opened, to form a leash.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A pet collar comprising:
a flexible collar portion including a releasable buckle and means for collar length adjustment;
a housing mounted on said collar, said housing bearing an extendable and retractable cable portion having a terminal end;
a hand strap portion connected to said cable portion terminal end, said hand strap portion bearing means for releasably fastening said hand strap portion flush to said flexible collar portion, so that said hand strap portion may be released from said flexible collar portion, and said cable portion extended from said housing to act as a leash.

2. The pet collar of claim 1 wherein said means for releasably fastening said hand strap portion flush to said flexible collar portion comprises a plurality of snaps.

3. The pet collar of claim 1 wherein said means for releasably fastening said hand strap portion flush to said flexible collar portion comprises velcro.

4. The pet collar of claim 1 wherein said extendable and retractable cable portion is normally biased to retract into said housing.

5. The pet collar of claim 4 wherein said extendable and retractable cable portion can be prevented from retracting after extension from said housing by a manual lock.

6. The pet collar of claim 1 wherein said extendable and retractable cable portion terminal end includes a swivel attachment to said hand strap portion.

7. The pet collar of claim 1 wherein said hand strap portion bears means for releasable attachment to itself, so that does not expand or otherwise create an opening which would create the potential for catching on an object.

8. The pet collar of claim 7 wherein said means for releasably fastening said hand strap portion to itself comprises a plurality of snaps.

9. The pet collar of claim 7 wherein said means for releasably fastening said hand strap portion flush to itself comprises velcro.

10. The pet collar of claim 1 wherein said hand strap portion comprises a loop.
